(19) United States
(12) Patent Application Publication
(10) Pub. No.: US 2006/0042563 A1
(43) Pub. Date: Mar. 2, 2006

(54) Animal paw covers

(76) Inventors: Mary Galloway, Honover Park, IL (US); Glen D. Galloway, Roselle, IL (US); Gerry M. Galloway, Hanover Park, IL (US); Gordon J. Galloway, Cary, NC (US)

Correspondence Address: BRINKS HOFER GILSON & LIONE, P.O. BOX 10395, CHICAGO, IL, 60610, US

(21) Appl. No.: 10/925,763

(22) Filed: Aug. 25, 2004

(51) Int. Cl. A01K 13/00

(52) U.S. Cl. 119/850

(57) ABSTRACT

An animal paw cover having a water-resistant receptacle is provided. The receptacle has an opening at one end and is substantially contoured to the shape of an animal paw. The receptacle is formed to receive and enclose the paw such that the receptacle is not loose-fitting when the paw is inserted through the opening. Advantageously, the receptacle is disposable.

### FIELD OF THE INVENTION

The present application relates to coverings for animal paws and more particularly to coverings for animal paws that are disposable.

### BACKGROUND

Typically, when an animal that is indoors is to go outside, there may be a concern about keeping the animal's paws clean. This concern can be due to not wanting the animal to return inside with dirty paws, thus requiring a person to clean up any floors the animal may walk upon. This may be tedious and time-consuming to the person, particularly if the floor is carpeted, by way of example, thus requiring the person to clean, and perhaps steam clean, the carpeting. Even if the floor is not carpeted, someone will still have to spend time cleaning the floor, whether with a mop, broom, or otherwise.

One solution is to clean the paws before the animal returns inside. However, this also may be time consuming, and may require the person cleaning the paws and the animal to remain outside in inclement weather until the paws are clean. Moreover, the animal may not have the patience to remain in place until its paws are clean.

Another solution is to use “paw boots.” The boots can be slipped over the paws of an animal before it goes outside. While the boots may keep an animal's paws clean, the boots themselves may need to be cleaned. These types of boots also may be expensive. Moreover, due to the wear and tear an animal may inflict upon the boots, additional expense may be incurred to replace the boots. In addition, these boots may be made out of a material that is not water-resistant, such as fleece, and thus will not keep the paws dry.

Moreover, because it is not unusual for an animal to go outside more than once per day, many of the above problems may be encountered and the time-consuming actions may be required several times throughout a day.

Accordingly, it would be desirable to have a device that overcomes the disadvantages and limitations described above.

### BRIEF SUMMARY

To alleviate the disadvantages of the prior art, an animal paw cover having a water-resistant receptacle is provided. The receptacle has an opening at one end and is substantially contoured to the shape of an animal paw and is formed to receive and enclose the animal paw such that the receptacle is not loose-fitting when the paw is inserted through the opening. The receptacle is disposable.

Another aspect of the present invention includes an animal paw cover that protects the paw of an animal and assists in reducing damage caused by the paw. The paw cover includes a water-resistant receptacle substantially contoured to the shape of an animal paw and formed to receive the paw. The paw cover is not loose fitting, and the receptacle is formed from one piece of material by heat sealing a first edge and a second edge of the material.

Another aspect of the present invention, the animal paw cover includes a water-resistant receptacle having an opening at one end. The receptacle is substantially contoured to the shape the shape of an animal paw and is formed to receive and enclose the animal paw inserted through the opening such that the paw cover is not loose fitting with respect to the animal paw. The receptacle is collapsible and thus easily storable after being removed from the paw.

According to another aspect of the present invention, a method for making a covering to protect the paw of an animal and to prevent damage caused by the paw is provided herein. At least one piece of a water-resistant material is provided that includes a first edge and a second edge. The first and second edges are heat-sealed together such that a receptacle having an opening is formed. The receptacle is formed to be substantially contoured to the shape of an animal paw.

### BRIEF DESCRIPTION OF SEVERAL VIEWS OF THE DRAWINGS

FIG. 1 is a perspective view of one embodiment of the paw cover showing a paw within the paw cover.

FIG. 2 is a perspective view of the paw cover of FIG. 1 showing a set of paw covers being worn by a dog.

FIG. 3 is a perspective view of an alternate embodiment FIG. 1 showing a paw cover having a piece of elastomeric material around the periphery of the opening of the paw cover.

### DETAILED DESCRIPTION OF THE PRESENTLY PREFERRED EMBODIMENTS

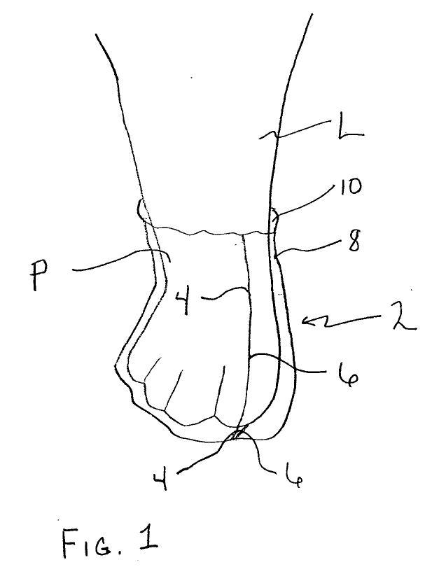

Turning now to the drawings, FIG. 1 shows an embodiment of a paw cover 2. The present embodiments contemplate an animal wearing the paw covers 2 on its paws when, for example, it is outdoors. Thus, the paw covers reduce the likelihood of an animal's paws becoming soiled, thus reducing the need to clean the paws to prevent damage to the surrounding environment when the animal comes inside and the paw covers are removed. Although an outdoor-to-indoor scenario is described, the paw covers may also be used in conjunction with other scenarios, such as, by way of example, an animal going from an unclean indoor environment to a clean indoor environment.

The paw cover 2 preferably is made from a water-resistant material, such as a water-resistant laminate. Preferably, the paw cover is made from polyolefins, but can also be made from other suitable materials. Examples of such materials include, but are not limited to, polyethylenes, polyesters, nylons, saran, and water-resistant paper or laminated materials.

The paw cover is preferably made from one unitary piece of material that includes a first edge 4 and a second edge 6. When forming the paw cover, the first and second edges 4, 6 are heat sealed together. Although any suitable heat sealing technique may be used, preferably the first and second edges are sealed together using a form-shaping bag machine. Although the sealed edges 4, 6 are shown as being pronounced in FIG. 1, depending on the material and sealing technique used, the sealed edges may also be less pronounced in other embodiments. As a result of sealing the first and second edges, a receptacle 8 is formed that includes an opening 10. The opening 10 allows an animal paw P to be inserted into the receptacle 8.

As will be readily apparent to those skilled in the art, the unitary piece of material must be designed so that when the first and second edges are sealed together, the resulting receptacle 8 will be formed to be compatible with an animal paw P and will thus be substantially contoured or formed to an animal paw so that the receptacle is not ill- or loose-fitting. Although a preferred embodiment contemplates one piece of material, in alternate embodiments at least two pieces, rather than one piece, of material may be used to form the paw cover.

As shown in FIGS. 1-3, the paw cover 2 preferably is formed so that it extends just slightly past the paw P. In additional embodiments, however, the paw cover may be formed so that it extends further up a leg L of an animal.

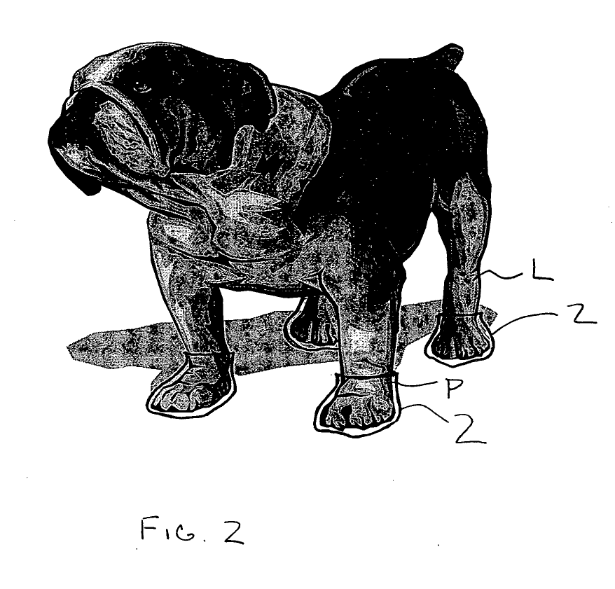

The use of the paw covers is as follows: A paw is inserted into the opening of the receptacle so that the receptacle surrounds the paw. This is repeated until all the paws are covered. FIG. 2 illustrates the paw covers being worn by a dog. After being used, i.e., worn by an animal, the paw covers are removed from paws. Once the paw covers are removed from the paws they may be discarded.

The nature of the materials and the manufacturing techniques used to make the paw covers allow the paw covers to be inexpensive and therefore disposable. Once the paw covers have been used, it is economically feasible to simply remove the paw covers from the paws and dispose of the paw covers. Moreover, due to the nature of the materials used, the resulting paw covers are lightweight and are collapsible, and therefore further lend themselves to being easily disposed of without taking up a large amount of space. Alternatively, depending on the state of the paw covers upon being worn, they may also be reused until it is decided that they should be discarded. Furthermore, the collapsible nature of the paw covers lends them to being easily storable without taking up a large amount of space.

The advantages of the disposable paw cover are numerous. Because the paw cover may be discarded, when it becomes soiled there is no need to spend time cleaning it, unlike other “paw boots” on the market that are not disposable. Since an animal may use the paw covers more then one time per day, this may be particularly advantageous since repeated cleanings of paw coverings will be avoided. Moreover, the paw covers may be inexpensive. Thus, they may easily be replaced if they are damaged due to the normal wear-and-tear that may be incurred.

Many “paw boots” that are available use a fleece-type of material. This material is not water-resistant, and thus may not keep the paws dry. Because the paw coverings of the present embodiments are made from a water-resistant material, the paws are more likely to remain dry, thus also providing for the comfort of the animal wearing the paw covers.

In addition to the paw cover embodiments described above, numerous other embodiments may be used. For example, although FIG. 1 shows the paw cover 2 as transparent, in additional embodiments, the paw cover may be opaque in appearance. Moreover, the paw cover also may be translucent in appearance.

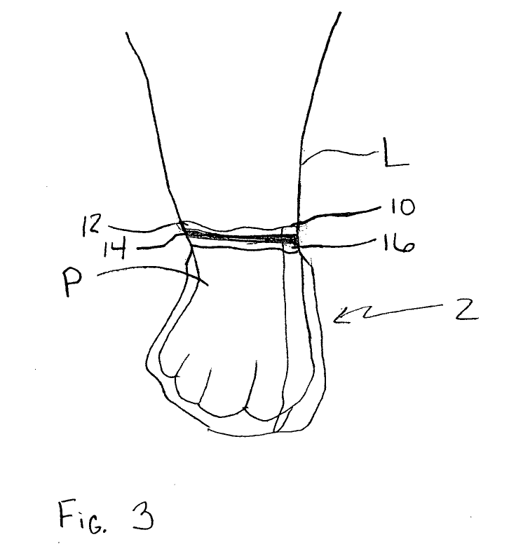

FIG. 3 shows an additional embodiment of the paw cover. An elastomeric material 14 has been placed around the periphery 12 of the opening 10. An edge 16 of the opening 10 has then been folded over to cover the elastomeric material and attached to the paw cover 2 so that the elastomeric material 14 remains around the periphery. The edge 16 may be attached through the sealing techniques described above for the first and second edges 4, 6. The elastomeric material provides for the periphery 12 of the paw cover 2 to “cling” to the paw P, thus providing further protection to a paw. Although an elastomeric material has been used to describe the embodiment shown in FIG. 2, as will be recognized by those skilled in the art, a rubber material or similar suitable material also may be used.

In addition, although FIG. 3 illustrates the paw covers as being worn by a dog, it is readily apparent that the paw covers may be made to be compatible with a variety of animals. Examples include, but are not limited to, cats, ferrets, or any type of animal with paws. Moreover, although the preferred embodiments contemplate the use of the paw covers with house pets, the paw covers may also be used in conjunction with animals in the circus or zoo, for example.

The embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

1. An animal paw cover comprising:
a water-resistant receptacle having an opening at one end, the receptacle being substantially contoured to the shape of an animal paw and formed to receive and enclose the paw such that the receptacle is not loose-fitting when the paw is inserted through the opening;
wherein the receptacle is disposable.

2. The animal paw cover of claim 1 wherein the receptacle is made of a polyolefin material.

3. The animal paw cover of claim 1 wherein the receptacle is made of a water-resistant paper.

4. The animal paw cover of claim 1 further comprising an elastomeric member around the periphery of the opening.

5. The animal paw cover of claim 1 further comprising a rubber member around the periphery of the opening.

7. The animal paw cover of claim 1, wherein the receptacle is transparent.

8. The animal paw cover of claim 1, wherein the receptacle is opaque.

9. The animal paw cover of claim 1, wherein the receptacle is translucent.

10. The animal paw cover of claim 1, wherein the receptacle comprises one unitary piece of material having first and second edges, whereby the first and second edges are heat sealed.

11. The animal paw cover of claim 10, wherein the first and second edges are heat sealed by a form-shaping bag machine.

12. The animal paw cover of claim 1, wherein the receptacle comprises at least two pieces of material, whereby an edge of each piece of material is heat sealed to an edge of another piece of material to form the receptacle.

13. The animal paw cover of claim 1, wherein a dog paw is inserted in the opening of the receptacle.

14. In an animal paw cover that protects the paw of an animal and assists in reducing damage caused by the paw, the improvement comprising a water-resistant receptacle being substantially contoured to the shape of an animal paw and formed to receive the paw, wherein the paw cover is not loose fitting, the receptacle being formed from one piece of material by heat sealing a first edge and a second edge of the material together.

15. The animal paw cover of claim 14, wherein the receptacle further comprises an opening to receive the paw and an elastomeric member around a periphery of the opening.

16. The animal paw cover of claim 14, wherein the receptacle is made of a polyolefin material.

17. The animal paw cover of claim 14 wherein the receptacle is made of a water-resistant paper.

18. An animal paw cover comprising:
a water-resistant receptacle having an opening at one end, the receptacle being substantially contoured to the shape of an animal paw and being formed to receive and enclose the animal paw when inserted through the opening such that the paw cover is not loose fitting with respect to the animal paw, the receptacle being collapsible and thus easily storable after being removed from the paw.

19. A method for making a covering to protect the paw of an animal and to prevent damage caused by the paw, the method comprising:
providing at least one piece of a water-resistant material having a first edge and a second edge; and
heat-sealing the first and second edges together such that a receptacle having an opening is formed; and
forming the receptacle to be substantially contoured to the shape of an animal paw.

20. The method of claim 19, wherein the step of providing comprises providing at least one piece of water-resistant material comprises a polyolefin material.

21. The method of claim 19, wherein the step of providing comprises providing at least one piece of water-resistant material comprises one unitary piece.

22. The method of claim 19, wherein the step of providing comprises providing a first piece of a water-resistant material and a second piece of a water-resistant material, the first edge of the first piece being heat sealed to the second edge of the second piece and the first edge of the second piece being heat sealed to the second edge of the first piece.

23. The method of claim 19, wherein the step of heat-sealing comprises sealing the first and second edges by a form-shaping bag machine.

24. The method of claim 19 further comprising:
placing a piece of elastomeric material around a periphery of the opening;
folding over an edge of the opening to cover the elastomeric material; and
heat sealing the edge of the opening to the receptacle.
